(19) United States
(12) Patent Application Publication
(10) Pub. No.: US 2004/0068477 A1
(43) Pub. Date: Apr. 8, 2004

(54) Method and system to publish the results of a search of descriptive profiles based on respective publication policies specified by owners of the descriptive profiles, and a profile service provider

(76) Inventors: David L. Gilmour, Los Altos Hills, CA (US); Jonathan M. Goldberg, San Francisco, CA (US)

Correspondence Address: Andre L. Marais, BLAKELY, SOKOLOFF, TAYLOR & ZAFMAN LLP, 12400 Wilshire Boulevard 7th Floor, Los Angeles, CA, 90025, US

(21) Appl. No.: 09/759,628

(22) Filed: Jan. 12, 2001

Related U.S. Application Data
(60) Provisional application No. 60/244,766, filed on Oct. 31, 2000.

(51) Int. Cl. G06F 7/00

(52) U.S. Cl. 707/1

(57) ABSTRACT

A method for facilitating user-authorized disclosure of profile information to a requesting entity involves the specification of notification and authorization rules pertaining to a composite profile or a collection of profiles. The notification and authorization rules specify appropriate responses to hits that occur as a result of matching operations against the composite profile or collection of profiles. The notification and authorization rules may specify appropriate responses on a profile by profile basis. The rules may further authorize publication of profile information to a requesting entity, or may specify that authorization for the publication of such information be expressly obtained from the subject (or owner) of the profile prior to any publication to the requesting entity. The composite profile, or collection of profiles, may include profile information submitted by a profile subject, or profile information harvested by an external profile owner (e.g., a website). The profile subject, while not being able to contribute or view the content of a profile constructed by a third party is nonetheless thus able to exercise a certain degree of control over the publication of information from such an external profile. A profile service provider may furthermore provide out-sourced profile construction and/or access management to one or more profile owners.

### CROSS REFERENCE TO RELATED APPLICATIONS

This application claims the benefit of U.S. Provisional Application No. 60/244,766, filed Oct. 31, 2000.

### FIELD OF THE INVENTION

This invention relates generally to the field of management and more particularly to a method and system to manage access to descriptive profiles of users in a manner that insures the privacy of the profiles, but at the same provides meaningful access thereto.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright © 1999, Tacit Knowledge Systems, Inc., All Rights Reserved.

### BACKGROUND OF THE INVENTION

In order to effectively market products, and to facilitate Customer Relationship Management (CRM), commerce facilities are motivated to fully understand the interests, habits, shopping behavior, demographics and other characteristics of potential customers so as to enable the commerce facility to better target advertising of services and merchandise to a potential customer base.

Members of the public, on the other hand, may be particularly reluctant to divulge such information on the grounds that this information may be utilized in an intrusive manner and to violate privacy. While on-line shoppers typically desire that an on-line shopping experience be customized to their interest, needs and wants, they may be uncomfortable with the idea that detailed personal information concerning them is being collected and utilized without their specific knowledge or consent, and often resold in the marketplace. There is accordingly tension between the consumer's desire for customization and their need for privacy.

In response to public concern regarding privacy on the Internet, “trustmarking” organizations have been formed to define guidelines for the handling of private and personal information gathered by the commerce retailers and also award privacy “seals” to websites. These organizations generally offer a set of guidelines for dealing with privacy issues, a pledge of compliance by member companies, and a brand campaign to allow these retailers to enhance the credibility of the compliance with the various privacy guidelines. These organizations, however, face inherent limitations in what they can control or assert over member sites to enforce compliance with guidelines. From the retailer's perspective, there is no real enforcement. Furthermore, the guidelines generally cover only information provided by users to the sites, and do not comprehensively deal with information inferred by a retailer based on a customer's behavior while navigating a website created by the retailer.

In some emerging business models, users are being compensated for supplying information regarding themselves. However, in the absence of guaranteed privacy protection for such personal information, users may be reluctant to provide such information because of uncertainty regarding the ultimate recipients and uses of the information. Further, the authentication of user-submitted identities and information is challenging to establish and administer. It would be valuable to individuals, to electronic retailers and to the growth of commerce generally if the users could be afforded a means to allow others to use information about them for purposes they choose to support, without obtaining access to underlying information itself.

### SUMMARY OF THE INVENTION

According to the present invention, there is provided a method including constructing a first profile utilizing first information concerning a target entity, wherein the first information is provided by the target entity. A second profile is constructed utilizing second information concerning the target entity, wherein the second information is provided by a further entity. A profile search is performed against both the first and second profiles, and a search result is processed according to a publication policy specified by the target entity.

The present invention describes systems, clients, servers, methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a block diagram illustrating a profiling system, according to an exemplary embodiment of the present invention.

FIG. 2 is a diagrammatic representation of an exemplary network environment that illustrates the distributed construction maintenance and storage of a profile regarding a profile subject, in the exemplary form of an individual, and an exemplary profile service provider may operate within the network environment to coordinate and facilitate access one or more profiles of the individual.

FIG. 3 is a diagrammatic representation of the architecture of a profile service provider, according to an exemplary embodiment of the present invention.

FIG. 4 is a diagrammatic representation of the structure of a query, according to an exemplary embodiment of the present invention.

FIG. 5 provides a diagrammatic representation query result, according to an exemplary embodiment of the present invention.

FIG. 6 is a diagrammatic of a composite profile, according to an exemplary embodiment of the present invention, that comprises a number of profile portions, each of the profile portions potentially contributed by a different profiler.

FIG. 7 is a table indicating exemplary access privileges to various profile portions of a composite profile.

FIGS. 8 and 9 are respective interaction diagrams illustrating interaction sequences between a requesting entity, a website, a profile service provider and a profile subject, according to alternative embodiments of the present invention.

FIG. 10 is a flow chart illustrating a method, according to an exemplary embodiment of the present invention, of facilitating authorized access to a profile, such as the composite profile illustrated in FIG. 6.

FIG. 11 is a diagram of one embodiment of a computer system suitable for performing any one of the methods discussed above.

FIG. 12 is an interaction diagram illustrating an interaction sequence in a peer-to-peer embodiment of the present invention.

### DETAILED DESCRIPTION OF THE INVENTION

A method and system to publish results of a search of descriptive profiles based on respective publication policies specified by owners of the descriptive profiles, and a profile service provider, are described. In the following description, for purposes of explanation, numerous specific details are set forth in order to provide a thorough understanding of the present invention. It will be evident, however, to one skilled in the art that the present invention may be practiced without these specific details. In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

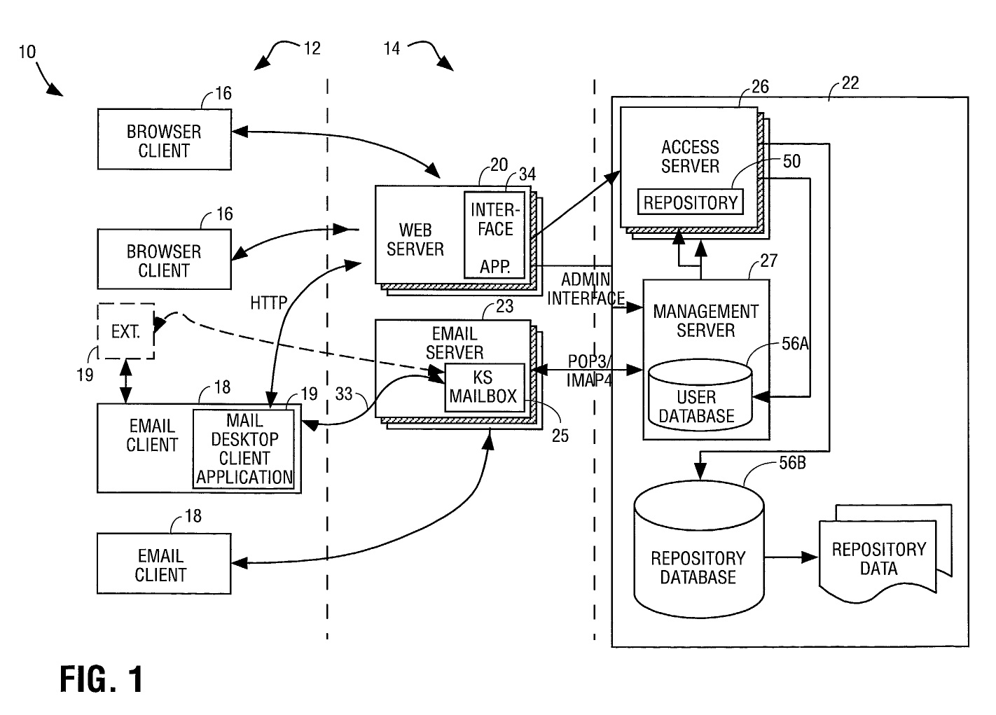

FIG. 1 is a block diagram illustrating an exemplary embodiment of a profiling system 10 that receives electronic documents, extracts terms therefrom that are potentially indicative of a profile of a user, and distributes a user profile constructed from the extracted profile terms. For the purposes of the present application, the word “term” shall be taken to include any acronym, word, collection of words, phrase, sentence, or paragraph.

The grammatical structure, length, frequency and density with which the extracted terms occur within the electronic documents, and prior history of use of the extracted terms within an organization may furthermore be utilized to attach a metric, in the form of a confidence level value, to the relevant terms for the purpose of grouping, ranking, and prioritizing such terms.

Terms may furthermore be stored in either a private or public portion of the user profile, depending upon the confidence level values thereof. With a view to determining which terms are truly indicative of a profile, a number of rules (or algorithms) may be exercised with respect to extracted terms to identify terms that are candidates for inclusion within a public portion of the user profile. Further rules (or algorithms) may be applied to an assembled profile for the purpose of continually organizing and refining the profile. Alternatively, the contents of a user's profile may be periodically reviewed or enhanced by the user (“owner”) to organize the public and private portions according to user preferences.

User control over the content of the private and public portions of the user's profile enhance the privacy of the system, protecting electronic documents from unwanted intrusion by others, including searchers. Unrestricted access to the public portion of the user profile may be provided to other users, for instance those in a particular organization. The private portion of a user profile may, on the other hand, have a restricted access and may require specific authorization by the owner for the provision of information concerning the user profile, and the owner, in response to a specific request.

The profiling system 10 may conveniently be viewed as comprising a client system 12 and a server system 14. The client system 12 includes clients with access to the server system 14, such as Internet browser clients 16 or e-mail clients 18, which may be resident on machines within the profiling system 10 or coupled to it through a computer network. Extensions 19 are incorporated into an e-mail client 18 to enable it to send electronic messages to a server 22. In particular, e-mail messages are copied to a special e-mail address 25 maintained by an e-mail server 23 that is associated with the server 22 (illustrated as arrow 32). As shown in FIG. 1, the extensions 19 may be integral with an e-mail client 18, or external to the client 18 and in communication therewith. Alternatively, the user of an e-mail client 18 may manually address an electronic document (e.g., an email) to the e-mail address 25, or e-mails from the client system 12 may be intercepted by the first server through which the e-mails pass and forwarded onto the server 22, thus eliminating the need for the extensions 19. The browser clients 16 provide an additional mechanism to submit documents to the server 22 through an interface application 35 maintained on a web server 20.

The server system 14 of the system 10 includes the web server 20, the e-mail server 23 and the server 22, although the invention is not so limited. The components of the server 22 illustrated in FIG. 1 are collectively responsible for examining and processing electronic documents received on the server system 14 from various sources, including the e-mail server 23 and the web server 20. Servers for other text-based applications used in the organization also may be considered part of the server system 14 and are interfaced into the server 22 through gateways (not shown). It will be further appreciated that alternate means of submitting electronic documents to the server 22, such as the implementation of standard application program interfaces (APIs), are contemplated as within the scope of the invention.

The server 22 includes a site management server 27 and an access server 26. The access server 26 provides a local, logical view of a repository 51, which is physically stored in a user database 56A and a repository database 56B. Once extracted from the electronic documents, profile terms may be processed so as to associate them with other profile terms within the repository 51 and to create or update profiles. Both databases 56A, 56B may store profile terms, as well as other data pertaining to users, the system, passwords, etc., in codes or other encrypted form that are only meaningful when accessed through the interfaces offered by system 10 to enhance privacy. The management server 27 is given access to the local view of the repository 51 maintained by the access server 26. It will be appreciated that although the user database 56A and the repository database 56B are illustrated as separate databases in FIG. 1, other physical and/or logical arrangements of the databases 56A, 56B and the corresponding repository 51 are equally applicable to the present invention.

The web server 20 facilitates access to the local view of the repository 51 by the browser clients 16 through the web server interface application 35. The web server 20 also facilitates profile queries, e-mail addressing based on profiles, and other types of access to the server 22.

Further details of an exemplary embodiment of the profiling system 10 and the creation and use of profiles are given in U.S. Pat. No. 6,115,709 entitled METHOD AND SYSTEM FOR CONSTRUCTING A KNOWLEDGE PROFILE OF A USER HAVING UNRESTRICTED AND RESTRICTED ACCESS PORTIONS ACCORDING TO LEVELS OF CONFIDENCE OF THE CONTENT OF THE PORTIONS, issued on Sep. 5, 2000 and assigned to the assignee of the present application, and which is hereby incorporated by reference.

Distributed Profiles

While the above described server 22 is useful, for example in a corporate environment, to allow users to create descriptive profiles concerning (1) themselves by the submission, for example, of electronic documents and (2) third parties by, for example, the submission of electronic files concerning such third parties, it will be appreciated that profiles concerning a particular entity (e.g., an individual) may be constructed in a number of different ways utilizing a number of different sources by a number of different entities. An individual may construct a descriptive profile, stored locally on a computer system operated by the individual, by the storage of certain descriptive information on that computer system. For example, an individual may store address, financial, preference and other descriptive information that the individual selectively publishes.

More commonly, a profile may be constructed by a third party concerning an entity (e.g., an individual) utilizing (1) information voluntarily submitted to that third party, (2) information inferred by the third party by observations of an entities activities and habits, and/or (3) information extrapolated by a third party from limited information gleaned in the previously mentioned manners. Consider for example that, in order to obtain a warranty (or guarantee) for many purchased products, the purchaser is required to complete a warranty form that is returned to the seller. The warranty form typically requires the purchaser to provide address, financial (e.g., income) and their descriptive information (e.g., number of children in household, etc.). Utilizing this information, the seller may construct a profile of the purchaser for use in marketing efforts, and for resale in the open market.

With the advent of electronic commerce, a number of commercial websites operated by retailers further harvest descriptive information regarding individuals by, for example, requiring that a user perform a detailed registration process in order to obtain full benefit of the website, and by monitoring user activities and actions (e.g., navigation) with respect to the website. To this end, a number of sophisticated software packages may be deployed in conjunction with a website to monitor user activities and actions with respect to the website. Such software packages have been developed and marketed by a number of vendors including, for example, BroadVision, Inc., Openmarket, Inc., and Intershop Communications. Such software packages are commonly referred to as portal software, website management software or Customer Relationship Management (CRM) software.

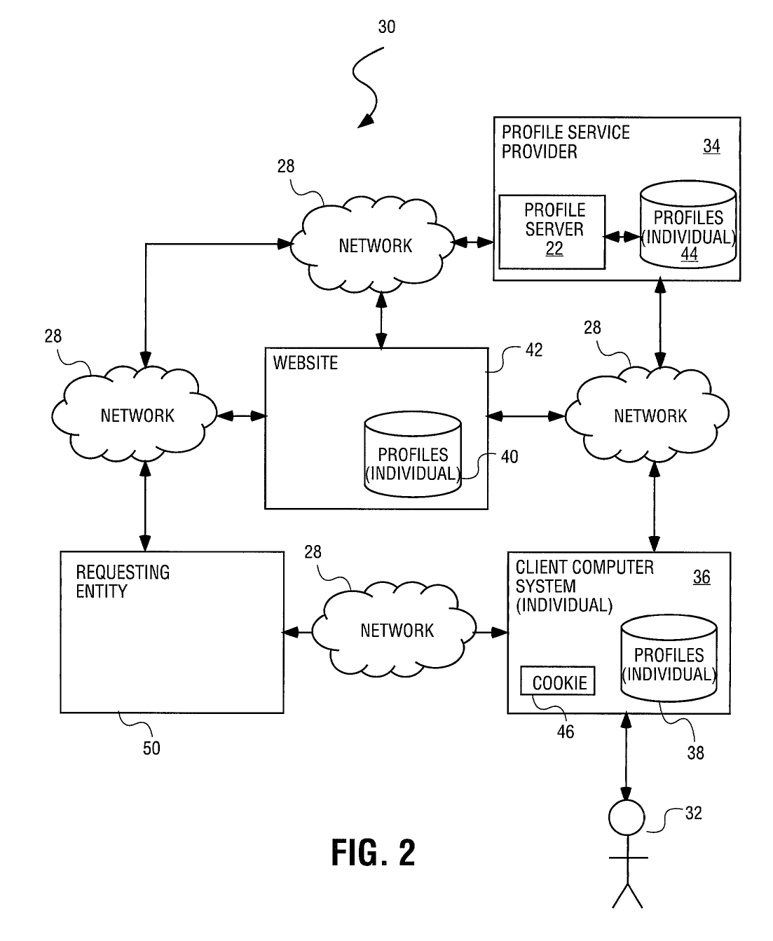

FIG. 2 is a diagrammatic representation of an exemplary network environment 30 that illustrates the distributed construction, maintenance and storage of a profile (or profiles) regarding an entity (e.g., an individual). A profile service provider 34, according to an exemplary embodiment of the present invention, is also shown on that may operate within the network environment 30 to coordinate and facilitate access to one or more profiles of the individual 32 in a manner that affords the individual 32 control over such access, but that also provides meaningful access to the profile by a requesting entity.

One or more profiles (or profile portions) for the individual 32 are shown to reside on distributed, networked computer systems. Specifically, a profile 38 may reside on a client computer system 36 operated by the individual 32. A further profile 40 may reside on computer systems of a remote operator in the form of a website 42, the profile 40 having being constructed, for example, in the manner described above by monitoring user activities and actions with respect to the website 42 and harvesting information from the individual 32 by way of registration questionnaires or other incentivized information gathering activities.

A further profile 44 regarding the user is shown to reside at the profile service provider 42. The profile 44, in one embodiment, is constructed as described above by the server 22 utilizing submissions of information thereto by the individual 32, or by other entities seeking to construct a profile of the individual 32. The profile service provider 34 may maintain multiple profiles 44 regarding a single individual 32, each of these profiles 44 being constructed by different entities. For example, the individual 32, utilizing the client computer system 36, may submit information to the profile service provider 34 for the purposes of constructing a file profile 44 that is stored and maintained by the profile service provider 34. Similarly, the website 42 may submit information to the profile service provider 34 for the construction of a profile 44 regarding the individual 32, this profile 44 constituting the website's 42 view or description of the individual 32.

It will also be noted that the client computer system 36 may store a cookie 46 that has been stored (or “dropped”) at the client computer system 36 by the website 42. As known in the art, the cookie 46 may be utilized to maintain state during a network access session from the client computer system 36 to the website 42 so as to enable the website 42 to track a “click stream” or other activities of the individual 32 with respect to the website 42. The cookie 46 may also be utilized to identify the individual 32 to the website 42 during an access session, so as to enable the website to personalize the presentation of information and intelligently target marketing activities to the individual 32 based on profile information accessible to the website 42.

In an alternative embodiment, state may be maintained between the client computer system 36 and the website 42 utilizing session identifiers.

Profiles for an individual 32 need not be maintained on each of the computer systems described with reference to FIG. 2. The distribution of multiple profiles, (or profile portions) constructed by multiple entities, concerning a single entity profile subject (e.g., the individual 32) may be inconvenient from the viewpoint of the specific profile subject. Consider that where multiple websites 42 each construct a respective profile 44 concerning an individual 32, it is extremely difficult for the individual 32 to exercise any control over such multiple profiles and to keep up to date regarding the publication policies of the websites 42 with respect to such profiles 40.

From the perspective of a website 42, it will also be appreciated that a single profile 40 constructed and maintained by that website 42 may provide a very limited and narrow view of the individual 32. For example, a website 42 specializing in the retail of computer equipment may not readily be able to ascertain a user's preferences and demographics outside the limited area of consumer electronics. Nonetheless, this profile may be valuable and regarded as a commodity from which revenue is derivable. To this end, the present invention proposes a profile service provider 34 that operates, in one embodiment, to construct, maintain and/or store profiles on behalf of profile owners. Specifically, the profile service provider 34 may enable specific entity (e.g., the individual 32) to construct and maintain a profile that the individual 32 selectively publishes to third parties. This profile may be physically stored on a client computer system of the individual 32 or at a storage facility provided by the profile service provider 34. Further, the profile service provider 34 may, in one embodiment, operate to provide an outsourced profile construction, maintenance, access and brokerage function to sellers and marketers (e.g., the website 42) and in this way to act as a so-called “Application Service Provider” (ASP) providing outsource profiling services.

In one exemplary embodiment, the profile service provider 34 may operate to construct and maintain profiles, regarding potential customers, for a retailer. In this embodiment, the profile service provider 34 receives profile information, for example harvested by a website 42, in the form of an eXtensible Markup Language (XML) document, that the server 22 then utilizes to construct and maintain a profile regarding a potential customer (e.g., the individual 32) on behalf of the website 42. In an alternative embodiment, the profile service provider 34 provides the service of constructing a profile 40 on behalf of a website, but the storage of the actual profile 40 may be to a location controlled by the website 42. In yet a further alternative embodiment, the service provider 34 is not responsible for the construction, storage or maintenance of a profile 40, but merely for facilitating and brokering access to the profile 40 by requesting entities other than the website 42.

In summary, the profile service provider 34 may provide any combination of services, including namely the construction of a profile (e.g., utilizing information submitted to the server 22), the storage of a profile, and the facilitation and brokerage of access to a profile. The facilitating of access to a profile (e.g., for the purposes of conducting a query against such a profile) does not necessarily require that the profile be stored on computer systems operated by the profile service provider 34. Such profiles may be distributed over a number of computer systems to which the profile service provider 34 has access via a network 28. For example, where profiles are distributed across a number of computer systems as illustrated in FIG. 2, a “peer-to-peer” architecture, as opposed to a traditional client-server architecture, may be implemented to facilitate access to the distributed profiles. For example, as opposed to having a centralized profile service provider 34, as illustrated in FIG. 2, a “plug-in” may be distributed to users, the plug-in having a community membership credential attached and containing community-specific profile extensions. The plug-in may then operate to facilitate community networking and interaction within and across communities under user control. Further details regarding a “peer-to-peer” embodiment of the present invention are provided below.

Dealing more specifically with the access service provided by the profile service provider 34, in one embodiment of the present invention, the profile service provider 34 seeks to allow a profile owner (e.g., an entity responsible for the construction of a profile) to maintain full access and control over an owned profile (e.g., of an individual) 32 and also potentially to make that profile accessible to third parties for querying purposes in a manner that is controlled by the profile owner and that is potentially revenue-generating for the profile owner. To this end, a profile owner may be the profile subject (e.g., where a profile is constructed by an individual 32 concerning the individual 32 and that is published in a controlled manner by the individual 32) or an external profiler (e.g., a website 42 that constructs a profile regarding a profile subject and that publishes the profile concerning the profile subject in a manner controlled by the website 42).

In summary, and as will be described in further detail below with respect to an access function, the profile service provider 34, in an exemplary embodiment of the present invention, operates to facilitate access by a requesting entity across potentially a number of profiles (or a composite profile including a number of portions) maintained by a number of profile owners. Further, the profile service provider 34 operates to control such access in a manner specified by a profile owner. Finally, the profile service provider 34 may operate to facilitate a transaction between a requesting entity and a profile owner, whereby the profile owner is compensated (e.g., by means of a monetary payment) for the access limited to a profile by the profile owner.

In one embodiment, where the profile owner is the profile subject, the present invention contemplates that the profile owner may construct both a private (or access restricted) profile and a public (or published) profile, which may be viewed as private and public portions of a profile. The public profile is differentiated from the private profile in that, a query hit (or match) against the public profile may be communicated to a requesting entity without specific permission from the profile owner, whereas a query hit against the private profile requires permission from the profile owner prior to communication to the requesting entity regarding the hit.

With final reference to FIG. 2, to this end, the network environment 30 is shown to include a requesting entity 50 that, in one embodiment, may issue profile queries via a network 28, to either a specific website 42 or to a profile service provider 34. In either case the profile service provider 34 operates to provide an access to one or more profiles (or profile portions), responsive to the queries and in accordance with publication policies specified by an owner of each profile to which the query is directed.

Profile Service Provider

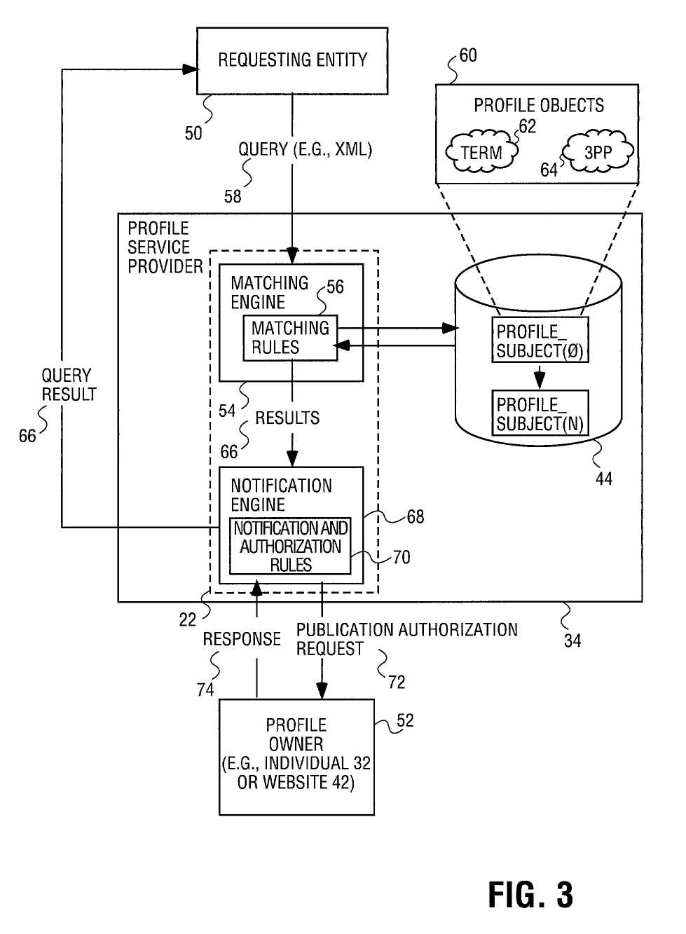

FIG. 3 is a diagrammatic representation of the architecture of the profile service provider 34, according to an exemplary embodiment of the present invention. The profile service provider 34 is shown to include a matching engine 54 that implements a set of matching rules 57 to locate one or more profiles 44 based on a received query 58. A requesting entity 50 may issue a query (e.g., in the form of an XML document) to the matching engine 54 which applies matching rules 57 to identify matched profiles based on criteria specified within the query.

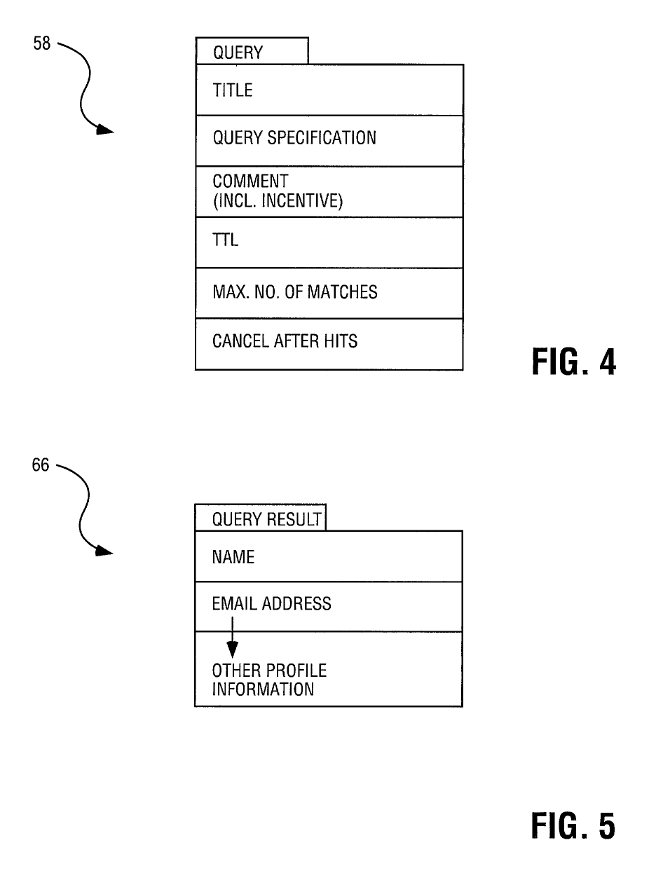

FIG. 4 is a diagrammatic representation of the structure of a query 58, according to an exemplary embodiment of the present invention. The query 58 may include a title, query specification, comment, time-to-live (TTL), specification of a maximum number of matches (or hits) and a specification of a number of “hits” after which a search, initiated responsive to the query, should be terminated. The query specification includes criteria for the performance of a matching operation by the matching engine 54. The query specification may include keywords, time and date limits, subject matter limits, or any criteria with respect to a field maintained within a profile 44.

The comment included within the query 58 includes text that may be communicated to a profile owner as part of a request for notification publication permission responsive to a query hit. As such, the comment may include the offer of an incentive to the profile owner for the granting of such permission. For example, a monetary or other incentive may be offered by the comment. The TTL specifies a time period (e.g., a predetermined number of hours or days) for which the query should remain extant and for which a profile owner may grant notification/publication permission.

The content of the query 58 may be inputted into a form (e.g., a markup language document) provided by the profile service provider 34 to a computer system of the requesting entity 50, the form prompting the requesting entity for the information to populate the query 58. The query 58 may thus be communicated to the profile service provider 34, via a network 28, as an HTML form output.

While the matching engine 54 is described as performing a search (e.g., a matching operation) against profiles 44 stored by the profile service provider 34, it will be appreciated that the search performed by the matching engine 54 may be performed against any profile 38 or 40 that is accessible by the profile service provider via a network 28.

In one embodiment, each profile 44 may be a collection 60 of profile objects. Each profile object typically includes a set of operations. Exemplary objects may include a term profile object 62 that stores a term (e.g., a word, collection of words, phrase or the like indicative of a item of a user), or a Platform for Privacy Preferences (P3P) object 64 that stores certain descriptive information concerning a profile subject. For example, a P3P object 64 may include shipping information, demographic information, financial information or the like that the profile owner is willing to have published, based on certain conditions (e.g., conditions concerning the privacy policy of a website 42 or a requesting entity 50).

Upon completion of a search by the matching engine 54 of a collection of profiles, the matching engine 54 produces a set of query results 66, each result 66 comprising a collection of information retrieved from profiles 44 against which hits occurred for the search conducted by the matching engine 54.

FIG. 5 provides a diagrammatic representation of an exemplary query result 66, which is shown to include the name, e-mail address or other profile information extracted from the profile 44 against which the hit occurred. It will be appreciated that a query result 66 may include any or all information contained within a profile. In one embodiment, the contents of the query result 66 may be specified by a query 58.

Returning to FIG. 3, the set of query result 66 is communicated from the matching engine 54 to a notification engine 68, which references a set of notification and authorization rules 70 to determine appropriate processing of the result 66. In one embodiment, the notification and authorization rules may constitute a publication policy, authored by a profile owner, that determines an action responsive to a hit against the identified profile 44. For example, a rule 70 may specify that all hits against a profile may be communicated to a requesting entity 50, without requiring permission, or authorization, for such notification from the profile owner. The rule 70 may further specify that a predetermined information (e.g., only interest information or interest, contact and identification information) be presented to the requesting entity 50 as part of a hit notification.

Alternatively, a rule 70 may specify that the profile owner 52 be notified of a hit, and that specific authorization for notification of the hit be required from the profile owner 52 prior to such notification to the requesting entity 50. As such, FIG. 3 illustrates communication, from the notification engine 68 to the profile owner 52, of a publication authorization request 72, responsive to which the profile owner 52 issues a response 74. The publication authorization request 72 may, in one embodiment, be a request for authorization to merely notify the requesting entity 50 of the hit, without disclosing any further details regarding the profile owner 52 for which the hit occurred. In a further embodiment, the publication authorization request 72 may be a request to in fact publish information extracted from the profile 44 against which the hit occurred to the requesting entity 50.

The response 74 may be an affirmative or negative response.

For each hit registered by the matching engine 54, the notification engine 68, dependent upon the notification and authorization rules 70, and possibly a response 74 from a profile owner 52, may publish a subset of query results 66 to the requesting entity 50. As discussed above, the query results 66 may be information extracted from a profile 44, or may merely be notification that a hit against a profile 44, or against a predetermined number of profiles 44, has occurred. In the case where the query results 66 merely indicates that one or more hits have occurred, the requesting entity 50 may determine whether a request for the actual contents of the profiles 44 against which the hit occurred is warranted based on, for example, the costs associated with the supply of this information.

Profiles and Publication Policies

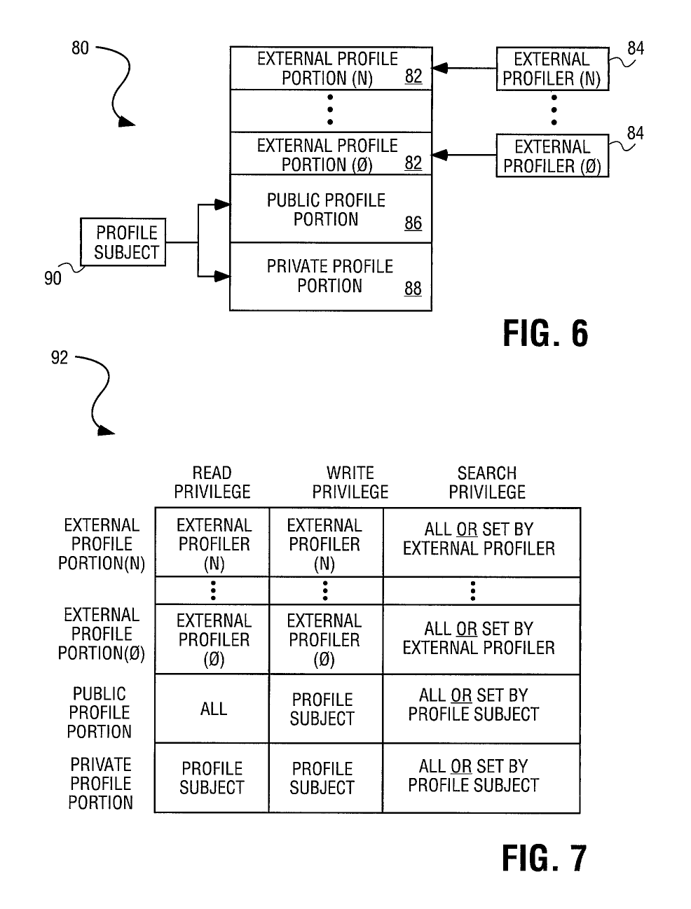

FIG. 6 is diagrammatic representation of a composite profile 80, according to an exemplary embodiment of the present invention, which comprises a number of profile portions, each of the profile portions potentially contributed by a different profiler. While the composite profile 80 is illustrated as a single profile, it will be appreciated that each of the profile portions may themselves be a stand-alone and distinct profile concerning a profile subject 90. Accordingly, the term “profile portion” shall be taken to include such a stand-alone, distinct profile, or part of a larger profile. Each of the profile portions of the composite profile 80 furthermore concerns a common profile subject 90.

A number of the profile portions are designated in FIG. 6 as external profile portions 82, indicating that these profile portions are constructed and contributed to by respective external profilers 84. For example, an external profiler 84 may be a website 42 that harvests information concerning an individual 32, and constructs the external profile portion 82 as a profile 40 that is maintained on a computer system operated by the website 42 and accessible by the profile service provider 34. In an alternative example, the website 42 may communicate information to the profile service provider 34 that enables the provider 34 to construct a respective external profile portion 82, as part of a unitary composite profile 80 concerning a profile subject 90 at a location controlled by the profile service provider 34. Accordingly, all profiles 40 constructed and contributed to by entities other than the profile subject 90 may be regarded as external profile portions 82 that the profile service provider 34 accesses and views as part of the composite profile 80.

The composite profile 80 is illustrated to include a public profile portion 86 and a private profile portion 88, which are constructed and contributed to by the profile subject 90. As described issued U.S. Pat. No. 6,115,709, the public profile portion 86 may constitute terms, or other searchable information, concerning the profile subject 90 that the profile subject 90 has made accessible for all searching and viewing purposes to third parties. The private profile portion 88, on the other hand, may merely be accessible for searching purposes, but notification and/or publication of hits against information contained in private profile portion 88 is subject to approval or authorization from the profile subject 90.

Within the context of the network environment 30 shown in FIG. 2, the public and private profile portions 86 and 98 may be constructed by the profile subject 90 (e.g., the individual 32) by submission of electronic files and documents to the server 22, via the network 28 in the manner described in U.S. Pat. No. 6,115,709.

Again, the public and private profile portions 86 and 98 may be viewed and accessed via the profile service provider 34 as part of a composite profile 80.

FIG. 7 is a table indicating access privileges to the various profile portions 82, 86 and 88. These access privileges, for example, are enforced by the access server 26 illustrated in FIG. 1. Alternatively, where an external profile portion 82 is maintained off-site of the profile service provider 34, the access privileges may be enforced by a profile owner (e.g., an external profiler 84 for the profile subject 90). The table 92 shown in FIG. 7 details read, write and search privileges for each of the external profile portions 82, as well as for each of the public and private profile portions 86 and 88. In an exemplary embodiment, it will be noted that, for the external profile portions 82, read and write privileges are limited to the profile owner 52 (i.e., the external profiler 84). However, search privileges against such external profile portions 82, as facilitated through the profile service provider 34, may be “public” and thus indicated as extending to “all”. Alternatively, the search privileges for each of the external profile portions 82 may be set by the external profiler 84, and limited to pre-identified parties. For example, the predetermined list of entities authorized to perform searches against each external profile portion 82 may be maintained.

Turning now to the public and private profile portions 86 and 88, while only the profile owner 52 has write privileges with respect to each of these portions 86 and 98, it will be noted in one embodiment, public read privileges to the public portion 86 are provided, while read privileges for the private profile portion 88 are again limited to the profile owner 52. Accordingly, the public profile portion 86 may be viewed as being profile information that profile owner 52 has authorized for relatively unrestricted publication.

In an alternative embodiment, read privileges to the public profile portion 86 may also be restricted by the subject 90 to a predetermined set of specified entities.

In one embodiment, the access privileges reflected in the table 92 shown in FIG. 7 may be encoded within a table that is accessible by both the rules 57 and 70, and the matching engine 54 and the notification engine 68 are accordingly responsible for the enforcement of these access privileges.

Methodology—Query/Response Against Profiles via a Profile Service Provider

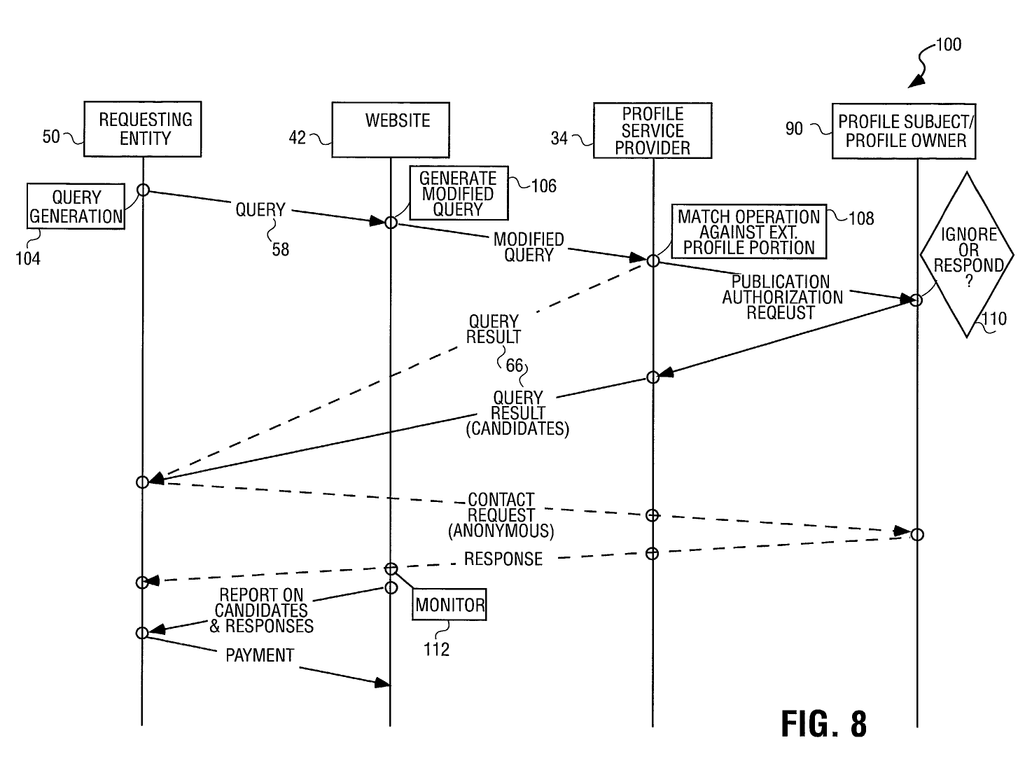

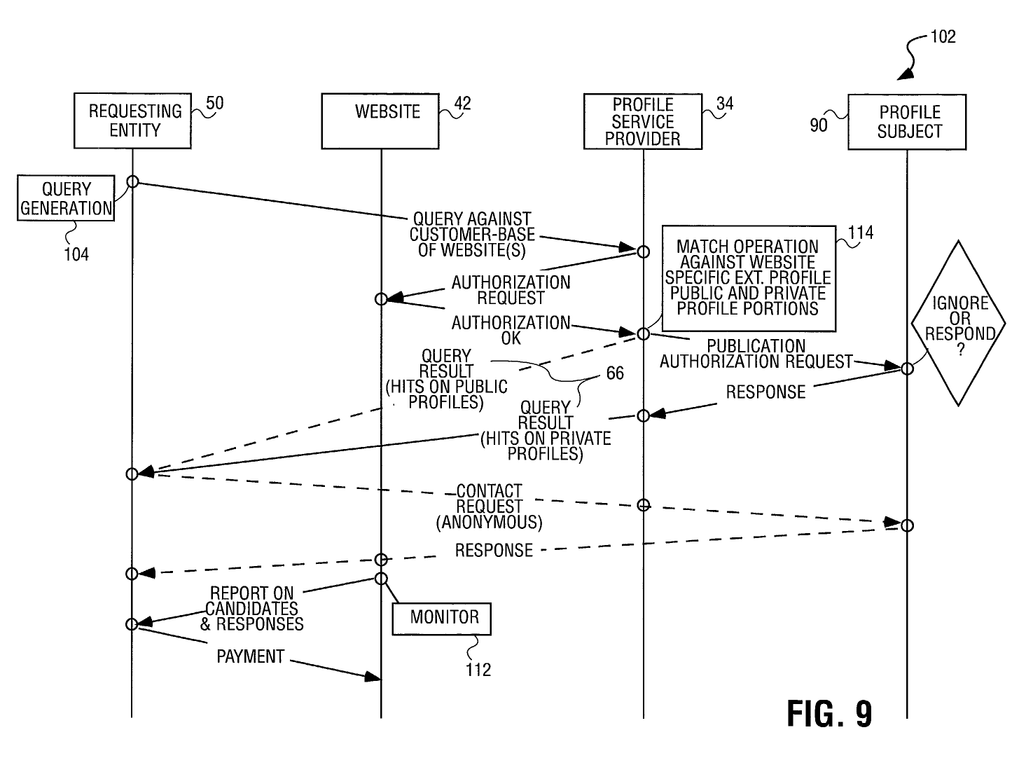

FIGS. 8 and 9 are respective interaction diagrams 100 and 102 illustrating interaction sequences between a requesting entity 50, a website 42, a profile service provider 34 and a profile subject 90, according to alternative exemplary embodiments of the present invention. The website 42, in one embodiment, provides an example of an external profiler 84, and both the website 42 and the profile subject 90 may be profile owners.

Turning first to FIG. 8, a requesting entity 50 is shown to generate a query 58 at block 104, the query for example being for the identification of profile subjects 90 based on criteria specified within the query (e.g., profile subjects that have published or shown an interest in digital cameras). The query 58 is then directed towards a website 42 (e.g., Amazon.com) for which the profile service provider 34 provides an outsourced profiling service, including the facilitation of access to external profile portions 82 owned and constructed by the website 42. As described above, the actual storage of the external profile portions 82 may be on computer systems controlled by the website 42 and/or the profile service provider 34.

At block 106, the website 42 generates a modified query for communication to the profile service provider 34. In one exemplary embodiment, the modified query may be an XML document constructed according to a Document Definition Type (DDT) specified by the profile service provider 34.

The modified query is then communicated from the website 42 to the profile service provider 34. At block 108, the profile service provider 34 performs a matching operation (for example, using the matching engine 54), against the external profile portions 82 composed by the website 42 to describe users that accessed the website 42.

The query results 66 are then communicated from the matching engine 54 to the notification engine 68, which accesses the rules 70, as defined by the website 42 and/or each of the profile subjects 90 against which a hit occurred.

Dependent upon the rules 70 as defined the profile subject 90 and/or the profile owner, a publication authorization request 72 may be issued from the profile service provider 34 to the profile subject 90 and/or the profile owner. For example, where Mr. Joe Smith is a customer of Amazon.com, a rule 70 specified by Joe Smith (i.e., the profile subject) may stipulate that any hits, against an external profile owned by Amazon.com and describing him, generate a publication authorization request. Alternatively, the rules 70 for the website 42 may specify that a publication authorization request 72 be issued to the website 42 (e.g., Amazon.com), in its capacity as a profile owner.

At block 110, the profile subject (or profile owner) may elect to ignore the request 72, or respond thereto by either authorizing or denying notification to requesting entity 50.

The profile service provider 34 then accumulates a collection of authorization responses 74 and communicates the query results 66 (e.g., limited identification of profile subjects 90 against which hits occurred) to the requesting entity 50.

Returning to block 108, it will be noted that certain query results 66 may be communicated to the requesting entity 50 without the communication of a publication authorization request 72 to a profile subject 90. This may occur in the case where a rule 70 specifies that no publication authorization request is required for one or more hits against profiles.

The communication of the query results 66 may be in the form of an HTML document providing limited identification (e.g., a name and/or demographic information) without any contact information. In this case, the requesting entity 50 is required to direct any contact requests (not shown) via the profile service provider 34. Alternatively, the query results 66 may, in an alternative embodiment, include contact details using which the relevant profile subjects 90 may be contacted (e.g., e-mail address or telephone number).

In the example provide in FIG. 8, profile service provider 34 acts as an intermediary between the requesting entity 50 and the profile subject 90 so as to main contain the anonymity of the relevant profile subjects 90. Specifically, responsive to the query results 66, the requesting entity 50 issues an anonymous contract request to all, or selected profile subjects 90 identified based on the query results 66. This contact request is forwarded by the profile service provider 34, which acts as a trusted third party, to each of the identified profile subjects 90.

The profile subjects 90 contacted as a result of the contact request may then elect to respond to the requesting entity 50, either through the profile service provider 34 or the website 42 so as to optionally maintain their anonymity. In an alternative embodiment, the profile subject 90 may communicate directly with the requesting entity 50, where anonymity is not a concern and the profile subject 90 wishes to make him or herself know to the requesting entity 50 for specific purposes. For example, the requesting entity 50 has identified a particular profile subject 90 as being a candidate for the purchase of a digital camera, the contact request communicated to the profile subject 90 may include an offer to sell a camera at a very favorable purchase price. The profile subject 90 may wish to purchase the camera, and thus make him-or-herself known to the requesting entity 50.

In one embodiment, the website 42 is shown to monitor responses from profile subjects 90 to the requesting entity 50 at block 112. This embodiment requires that responses be channeled through the website 42. This enables the website 42 to report to the requesting entity 50 regarding candidates and responses, and thus quality a payment from the requesting entity 50 for access to a profile (e.g., an external profile portion 82) that is constructed and owned by the website 42. For example, the requesting entity 50 and the website 42 may enter an agreement in terms of which payment is made to the website 42 by the requesting entity on the basis of a number candidate profile subjects 90 included in the query results 66. Further, a payment to the website 42 may be made dependent upon the number of responses received by the requesting entity 50 responsive to the anonymous contact request. In yet a further embodiment, the payment made from the requesting entity 50 to the website 42 may be dependent upon a number of transactions concluded between requesting entity 50 and profile subjects 90.

It will thus be appreciated that the profile service provider 34, in the illustrative example discussed above with reference to FIG. 8, provides a convenient mechanism whereby a website 42 may make a profile database that it has constructed available to third parties (e.g., the requesting entity 50), for example, in exchange for payment. The profile service provider 34 further provides the mechanism whereby the profile owner, or the profile subject 90, may specify rules in terms of which the profile subject 90 is made known to the requesting entity. In this way, a profile subject 90 (e.g., Mr. Joe Smith) for which a website 42 (e.g., Amazon.com) maintains a profile may be provided with control over publication of profile information responsive to a match against his or her profile, even though the profile subject 90 has no read or write privileges with respect to the profile owned by the website 42. The ability of the website 42 to construct profiles describing its customers is thus not compromised, and the profile subjects 90 are not provided with a view of the profiles as constructed by the website 42. The profile subjects 90 are nonetheless provided with a degree of control over the dissemination and utilization of respective profiles by the website 42, and may thus be more inclined to authorize or tolerate profiling activities of the website 42.

In summary, FIG. 8 deals with the situation where the profile service provider 34 operates to assist a profile owner (e.g., the website 42) in the monetarization of a database of profiles constructed by the profile owner by facilitating queries by third parties against that specific database of profiles.

FIG. 9 is an interaction diagram illustrating a sequence 102 of interactions between a requesting entity 50, a profile owners in the form of website 42, the profile service provider 34 and a profile subject 90. In this example, the query generated by the requesting entity 50 at block 104 is communicated directly to the profile service provider 34. The query generated at block 104 may specify that the requesting entity 50 wishes to run the query against the profile databases (e.g., the external profile portions 82) of specific external profilers (e.g., identified websites 42) and/or private and public profile portions 86 and 88 of a profile 80 constructed by the profile subject 90, to which the profile service provider 86 has access. It is envisaged that the requesting entity 50 may specify the scope of the query (e.g., identify which external profile portions 82 that the query is to be run against, and also identify the profile portions 82 and 88 be searched).

Responsive to the query, the profile service provider 34 is shown to issue an authorization request 72 to the external profiler 84 (e.g., the website 42) for authorization to run the query against the external profile portion 82 owned by the relevant profiler 84. An agreement between the profile service provider 34 and a website 42, for example, may furthermore specify that a payment be made to the website 42 for authorizing access to its profile database. Such payment may be made directly from the requesting entity 50, or via the profile service provider 34. In this way, the profile service provider 34 may in fact act as a broker of access to the profile databases of multiple websites 42 and other external profilers 84.

Returning to the interaction diagram shown in FIG. 9, responsive to an authorization grant from the website 42, the profile service provider 34, at block 114, performs a matching operation against each of the external profile portions 82 (e.g., proprietary profile databases) of the external profilers 84 from which the profile service provider 34 has obtained authorization. The matching operation may also be performed against the public and private portions 86 and 88 constructed by the profile subject 90.

As described above with reference to FIG. 8, when required by rules 70 specified by profile subjects 90 against which hits occur in either the external profile portions 82 or the private profile portion 88, publication authorization requests 72 are issued from the profile service provider 34 to the relevant profile subjects 90. On the other hand, should hits occur against the public profile portion 86, or external profile portions 82 for which rules 70 do not require notification, query results 66 may be communicated directly to the requesting entity 50. Otherwise the query results 66, which generated as a result of hits that occurred against other private portions or external profile portions for which a rule 70 requires authorization, are published to the requesting entity 50 upon receipt of an affirmative response from the profile subject 90.

It should furthermore be noted that the query results 66 are typically not communicated as separate dispatches from the profile service provider 34 to the requesting entity 50, but are communicated after detection of a maximum number of matches for which publication has been authorized (as specified within the query 58), or after a predetermined time period subsequent to the issuance of the request (as specified by the TTL within query 58 as shown in FIG. 4).

In summary, the interaction sequence 102 shown in FIG. 9 differs from that shown in FIG. 8 in that the query 58 is issued directly to the profile service provider 34, and may then run the query against multiple external profile portions 82 owned by multiple respective external profilers 84. Furthermore, each of the external profilers 84 may in this way extract some value from owned profile databases by facilitating access to such profile databases via the profile service provider 34.

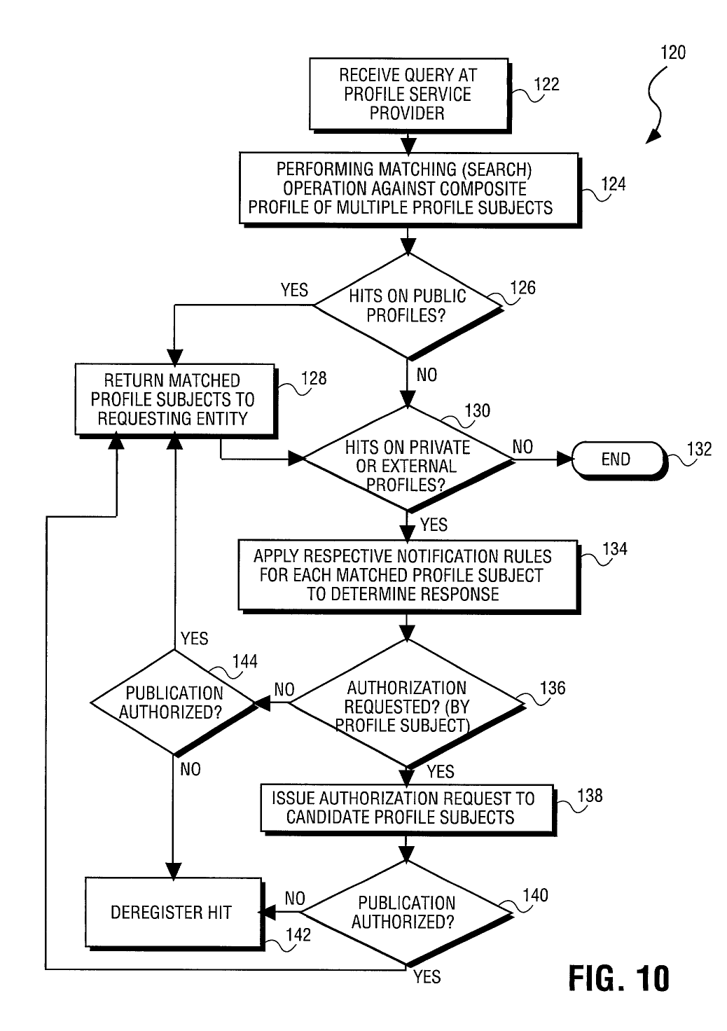

FIG. 10 is a flow chart illustrating a method 120, according to an exemplary embodiment of the present invention, of facilitating authorized access to a profile, such as for example the composite profile 80 illustrated in FIG. 6.

The method 120 commences at block 122 with the receipt of a query 58 at a profile service provider 34 in the manner described above. For example, the query 58 may be received directly from a requesting entity 50, or may be directed to the profile service provider 34 via a website 42 or other profile owner.

At block 124, the profile service provider 34 performs a matching operation (e.g., a search) against a composite profile 80 for each of multiple profile subjects 90, utilizing a criteria defined in the received query 58. It will be appreciated that the composite profile 80 may comprise one or more external profile portions 82 contributed by one or more external profilers 84, and/or public and private profile portions 86 and 88 contributed by the profile subject 90.

At decision block 126, a determination is made, for example by the notification engine 68, whether any hit has been registered as a result of the matching operation against public profile portions 86 in any of the composite profiles 80. If so, at block 128, the notification engine 68 proceeds to return information concerning the profile subjects 90 for which hits were detected.

Following a negative determination at decision block 126, or following block 128, a determination is made at decision block 130 whether any hits were registered against a private profile portion 88, or one or more external profile portions 82, of respective composite profiles 80 searchable by the profile service provider 34. If no such hits are detected, the method 120 terminates at block 132.

On the other hand, should hits against the private or external profile portions 82 have occurred, at block 134, the notification engine 68 proceeds to apply respective notification and authorization rules 70 for each of the matched profile subjects 90 to determine an appropriate notification response.

At decision block 136, a determination is made by the notification engine 68 whether the rules 70 require that an authorization request 72 be issued to the relevant profile subject 90 prior to determining whether publication of the hit is authorized.

Following a positive determination at decision block 136, the profile service provider 34, as illustrated in FIGS. 8 and 9, issues an authorization request 72 to the respective profile subjects 90, following which a determination is made at decision block 140 whether affirmative publication authorizations have been received from any of the respective candidate profile subjects 90.

If it is determined at decision block 140 that a publication authorization has been received from a profile subject 90, information concerning the relevant profile subject 90 is communicated to the requesting entity 50 at block 128.

On the other hand, should no publication authorization be received from a respective profile subject 90, the hit against the composite profile 80 for the respective profile subject 90 is deregistered at block 142.

Returning to decision block 136, if it is determined that the relevant rules 70 for a particular profile subject 90 do not require express authorization from the profile subject 90, a determination is made at block 144 whether the rules 70 permit the publication of profile information concerning the profile subject 90 to the requesting entity 50. If not, the relevant hit is again deregistered at block 142. Alternatively, if it is determined at decision block 144 that publication of profile information to the requesting entity has been authorized, information concerning the relevant profile subject 90 is communicated to the requesting entity 50 at block 128.

It should be noted that the notification and authorization rules 70, which determine whether authorization for publication has been requested by a profile subject 90 at block 136, or whether publication has been authorized at publication block 144, may be more complex than a simple yes/no determination. For example, the rules 70 may specify that queries 58 received from an identified set of requesting entities 50 may require notification authorization. Similarly, the rules 70 defined by a profile subject 90 may specify that queries 58 pertaining to certain subject matter (e.g., digital cameras) received during a certain time period, having a certain urgency or complying with a further user-specified criteria require (or do not require) notification and/or publication authorization. For example, a profile subject 90 may wish to make his or her identity, and profile information, known to the requesting entities 50 that are interested in marketing digital cameras (or any other specified product or service). In this case, the profile subject 90 may authorize publication of profile information and/or contact details to the requesting entity 50 without specific authorization responsive to a particular query 58. Similarly, a profile subject 90 may indicate that all queries 58 received from Amazon.com do not require express authorization from the profile subject 90. Authorization information embedded within the notification rules 70, or as expressly provided by the profile subject 90 responsive to an authorization request at block 138, may also include varying degrees of authorization. For example, a first level authorization may authorize only notification of a hit to the requesting user 50 without any identifying information concerning the profile subject 90. A second level of authorization may be for the publication of limited profile information (e.g., demographic information) to the requesting entity 50, but not authorize the publication of any identifying or contact information regarding the profile subject 90. A third level of authorization may authorize the publication of demographic information, identifying information and contact information regarding the profile subject 90 to the requesting entity 50.

Computer System

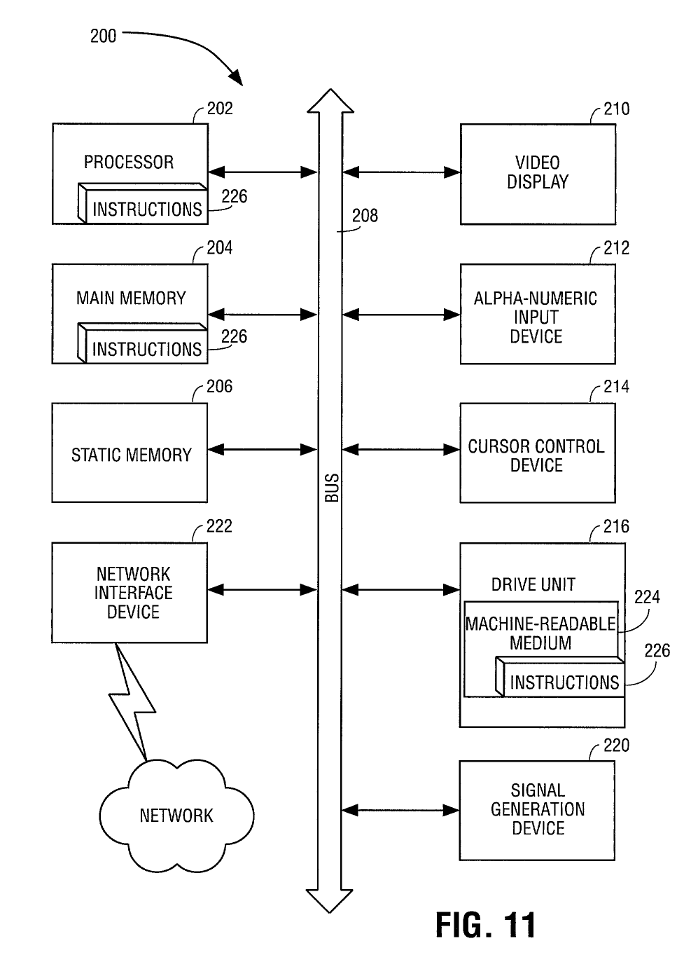

FIG. 11 is a diagrammatic representation of a machine in the form of computer system 200 within which software, in the form of a series of machine-readable instructions, for performing any one of the methods discussed above may be executed. The computer system 200 includes a processor 202, a main memory 204 and a static memory 206, which communicate via a bus 208. The computer system 200 is further shown to include a video display unit 210 (e.g., a liquid crystal display (LCD) or a cathode ray tube (CRT)). The computer system 200 also includes an alphanumeric input device 212 (e.g., a keyboard), a cursor control device 214 (e.g., a mouse), a disk drive unit 216, a signal generation device 220 (e.g., a speaker) and a network interface device 222. The disk drive unit 216 accommodates a machine-readable medium 224 on which software 226 embodying any one of the methods described above is stored. The software 226 is shown to also reside, completely or at least partially, within the main memory 204 and/or within the processor 202. The software 226 may furthermore be transmitted or received by the network interface device 222. For the purposes of the present specification, the term “machine-readable medium” shall be taken to include any medium that is capable of storing or encoding a sequence of instructions for execution by a machine, such as the computer system 200, and that causes the machine to perform the methods of the present invention. The term “machine-readable medium” shall be taken to include, but not be limited to, solid-state memories, optical and magnetic disks, and carrier wave signals.

If written in a programming language conforming to a recognized standard, the software 226 can be executed on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a machine, such as the computer system 200, the machine to perform an action or produce a result.

The preceding description of FIG. 11 is intended to provide an overview of computer hardware and other operating components suitable for implementing the invention, but is not intended to limit the applicable environments. One of skill in the art will immediately appreciate that the invention can be practiced with computer architectures and configurations other than that shown in Figure N, including hand-held devices, multiprocessor systems, microprocessor-based or programmable consumer electronics, network PCs, minicomputers, mainframe computers, and the like. A typical computer system will usually include at least a processor, memory, and a bus coupling the memory to the processor. The invention can also be practiced in distributed computing environments where tasks are performed by remote processing devices that are linked through a communications network.

Peer-to-Peer Exemplary Embodiment

As mentioned above, the present invention may be implemented utilizing the above described client-server architecture, or utilizing a distributed or peer-to-peer architecture. In the exemplary peer-to-peer architecture, a peer-to-peer (P2P) “plug-in” may be distributed to each client computer system 36 on which is stored a profile 38 so as to facilitate access to the relevant profile 38, under control of the user 32. The plug-in may also embody a “community” membership credential, and contain community-specific extensions. In this embodiment, the term “community” refers to a community of entities participating in a user-controlled profile sharing community.

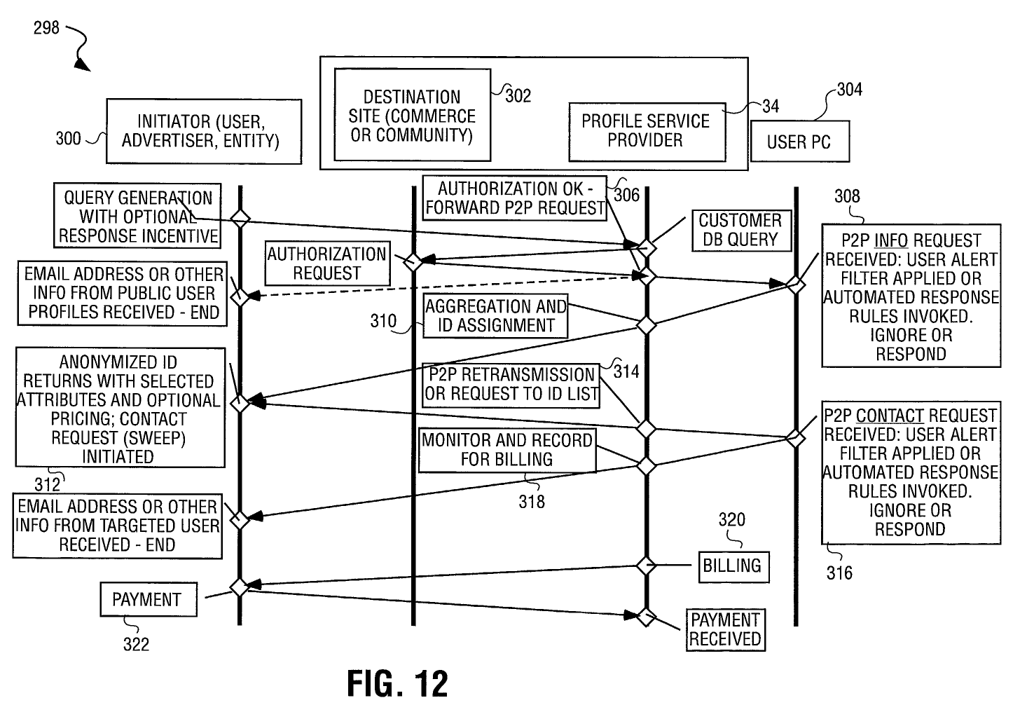

FIG. 12 is an interaction diagram illustrating a sequence 298 of interactions that may be facilitated by, inter alia, the P2P plug-in to implement the P2P embodiment of the present invention. This interaction diagram bears similarities to the diagram illustrated in FIG. 9, but differs in that the profile service provider 34 does not itself perform a match operation, but performs an authorization function for P2P requests (block 306) and then propagates such P2P requests across a network to multiple user compilers 304. Match operations, under the control of the P2P plug-ins are then performed locally at each of the user computers 304. Specifically, the P2P plug-in, upon receiving an authorized request from the profile service provider 34, applies user alert filters and/or automated response rules when conducting a match based on a P2P “information” request, to which the relevant user may respond, or may otherwise choose to ignore (block 308).

The profile service provider 34, in the exemplary embodiment illustrated in FIG. 12, may also serve to aggregate and “anonymize” responses, responsive to a P2P information request issued to multiple users (block 310).

Having anonymized responses to these P2P information requests, the profile service provider 34 may then communicate the results of the P2P information request to an initiator 300, together with selected attributes (e.g., profile characteristics) and pricing options (block 312).

Responsive to the results of the P2P information request, the initiator 300 may then issue a contact request (or “sweep”) to the profile service provider 34, which then issues a P2P “contact” request to a list of users, potentially identified by the initiator 300 from the anonymized identities communicated to the initiator 300.

Upon receiving a P2P contact request at a user computer 304, a P2P plug-in may then operate to apply user alert filters and/or invoke automated response rules (block 316). Again, the user may choose to ignore the P2P request, or respond thereto.

The profile service provider 34 monitors responses from users to the P2P contact request for billing purposes (block 318) and may again aggregate responses to the P2P contract request for communication to the initiator 300. The aggregated response communicated from the profile service provider 34 to the initiator 300 may constitute, for example, e-mail addresses and other information from the targeted users utilizing which the initiator 300 may contact the relevant users.

The profile service provider 34 again provides billing information to the initiator 300, the billing information indicating a payment due to the profile service provider 34 for brokered access to the profiles of user (block 320), responsive to which the initiator 300 makes a payment to the profile service provider 34 (block 322).

A method and system to publish results of a search of descriptive profiles based on respective publication policies specified by owners of the descriptive profiles, and a profiling service provider have been described. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

What is claimed is:

1. A method including:
constructing a first profile utilizing first information concerning a profile subject, wherein the first information is provided by the profile subject; and
constructing a second profile utilizing second information concerning the profile subject, wherein the second information is provided by a further entity,
wherein a profile search is performed against the both the first and second profiles and wherein a search result is processed according to a publication policy specified by the profile subject.

2. The method of claim 1 wherein write access to the first profile is limited to the profile subject.

3. The method of claim 1 wherein read access to the first profile is limited to the profile subject.

4. The method of claim 1 wherein search access to the first profile is extended beyond the profile subject.

5. The method of claim 6 wherein the search access to the first profile is unrestricted.

6. The method of claim 1 wherein write access to the second profile is limited to the further entity.

7. The method of claim 1 wherein read access to the second profile is limited to the further entity.

8. The method of claim 1 wherein search access to the second profile is extended beyond the further user.

9. The method of claim 8 wherein the search access to the second profile is unrestricted.

10. The method of claim 1 wherein the publication policy specifies that the profile subject be prompted for authorization to publish the search result.

11. The method of claim 10 wherein the publication policy specifies that the profile subject be prompted for authorization to publish the search result when the search registers a match with respect to the second profile.

12. The method of claim 1 wherein the first profile includes a public profile portion and a private profile portion, and wherein the publication policy specifies that the profile subject be prompted for authorization to publish the search result when the search registers a match with respect to the private profile portion.

13. The method of claim 10 wherein the authorization is to publish the search result to an initiator of the search.

14. The method of claim 1 wherein the publication policy specifies that the search result be published without independent authorization by the profile subject.

15. The method of claim 14 wherein the first profile includes a public profile portion and a private profile portion, and wherein the publication policy specifies that the search result be published without the independent authorization by the profile subject when the search generates a match against the public profile portion.

16. The method of claim 1 wherein the publication policy specifies that the search result not be published.

17. The method of claim 1 wherein the publication policy includes a rule authored by the profile subject.

18. The method of claim 1 wherein the publication policy specifies at least one search criteria to be applied when a profile search is performed against any one of the first and second profiles.

19. The method of claim 18 wherein the search criteria defines a requirement for the performance of the profile search.

20. The method of claim 19 wherein the requirements is that the profile search be related to specific subject matter.

21. The method of claim 1 wherein the first and second profiles form respective portions of a common profile.

22. The method of claim 1 wherein the first and second profiles reside at separate and distinct network location.

23. The method of claim 1 wherein the first and second profiles reside at a common network locations.

24. The method of claim 1 wherein the profile search is performed against a plurality of profiles and wherein the search result is processed according to the publication policy.

25. The method of claim 3 wherein the read access is denied to a host computer that hosts the first profile.

26. A system including:
a profile system to store a profile concerning a profile subject, the profile including a first profile including first descriptive information concerning the profile subject and provided by the profile subject, and a second profile including second descriptive information concerning the profile subject and provided by a further entity; and
a matching system to perform a profile search against the first and second profiles, and to process a search result, generated by the profile search, according to a publication policy specified by the profile subject.
